(19) United States
(12) Patent Application Publication
(10) Pub. No.: US 2014/0033031 A1
(43) Pub. Date: Jan. 30, 2014

(54) METHODS AND SYSTEMS FOR CONTINUOUS PREFLIGHT

(71) Applicant: Matthew J. Phillips, Champaign, IL (US)

(72) Inventor: Matthew J. Phillips, Champaign, IL (US)

(21) Appl. No.: 12/173,752

(22) Filed: Jul. 15, 2008

(51) Int. Cl. G06F 3/14

(52) U.S. Cl. 715/274

(57) ABSTRACT

A preflight engine configured to preflight multiple portions of a document substantially in parallel by using multi-threadings or time slicing. A controller manages the portions and interacts with the preflight engine to determine which of the portions is to be preflighted next. An observer is coupled to the preflight engine to notify the preflight engine when there is a document to preflight or when a change occurs to a document being preflighted. A database is used to store results of the preflight and the corresponding portions.

### COPYRIGHT NOTICE

Portions of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2008, ADOBE SYSTEMS INCORPORATED. All Rights Reserved.

### TECHNICAL FIELD

The present application relates generally to the technical field of document processing. For example, an embodiment of the invention relates to processing multiple portions of a document substantially in parallel.

### BACKGROUND

In general, preflight is a process that enables users to check a document for errors. The preflight is applied so that errors can be corrected before the document is sent to a printer. For example, the document may be an electronic version of a magazine, and errors in the document can prove to be expensive when the magazine has to be reprinted to remove the errors. An example of preflight features may be found in ADOBE® ACROBAT of Adobe Systems of San Jose, Calif.

A preflight rule is a small bit of intelligence (and parameters) that looks for a particular kind of problem in a document. For example a rule may look for text that is too small. Such a rule might have two parameters which include whether to check the text and if the text is to be checked, whether the text is too small. The first parameter is the on/off state of the rule. The second parameter is a threshold value to determine whether the text is too small. For example, the threshold may be four (4) points or 0.055 inches in height. A preflight profile may simply be a collection of preflight rules. Each preflight profile may be associated with a preflight name. For example, there may be a preflight profile called “Magazine” which includes preflight rules that may be used to check for errors in a document that will be used as part of a magazine publication. The preflight rules in the “Magazine” preflight profile may restrict the document from having any spot colors and from having any text smaller than 6 points in size, and so on.

### BRIEF DESCRIPTION OF DRAWINGS

Some embodiments are illustrated by way of example and not limitation in the figures of the accompanying drawings in which:

FIG. 1 illustrates an example of a preflight system, in accordance with some example embodiments.

FIG. 2 is a block diagram illustrating a preflight process, in accordance with some example embodiments.

FIG. 3 is a block diagram that illustrates a process that may be performed by an observer, in accordance with some example embodiments.

FIG. 4 is a table that illustrates data structure examples that may be used to store data in a database, in accordance with some example embodiments.

FIG. 5A is a block diagram that illustrates a process that may be performed by a controller when interacting with a database and a preflight engine, in accordance with some example embodiments.

FIG. 5B is a block diagram that illustrates a process that may be performed by a controller when interacting with an observer, in accordance with some example embodiments.

FIGS. 6A-C illustrates examples of a directed graph, in accordance with some example embodiments.

FIG. 7 illustrates another example of a directed graph, in accordance with some example embodiments.

FIG. 8A is a block diagram that illustrates a process that may be performed by a controller, in accordance with some example embodiments.

FIG. 8B is a block diagram that illustrates a process that may be performed by the controller when inspection results are generated by the preflight engine, in accordance with some example embodiments.

FIG. 9 is a block diagram that illustrates a process that may be performed by the controller when receiving information from an observer, in accordance with some example embodiments.

FIG. 10 is a block diagram of machine in the example form of a computer system within which instructions, for causing the machine to perform any one or more of the methodologies discussed herein, may be executed, in accordance with some example embodiments.

### DETAILED DESCRIPTION

For some example embodiments, methods and systems to apply a preflight profile to a document may enable a user to review preflight errors while the preflight is operating in the background. In the following description, for purposes of explanation, numerous specific details are set forth in order to provide a thorough understanding of some example embodiments. It will be evident, however, to one skilled in the art that the present invention may be practiced without these specific details.

### Overview

A preflight is usually initiated by a user. First, the user selects a target document and a preflight profile. There may be a set of preflight profiles for a user to select from. Once a preflight profile is selected, the preflight may traverse the content of the document, applying the preflight rules (also referred to as rules) and generating a report of errors as they are encountered. For example, the preflight may check the document for errors associated with fonts, colors, and alignment. The user is presented with the results which can be saved as a report. Those results become a starting point of a separate process of correction.

Because the preflight is initiated by the user (i.e., on-demand basis), the user may work for long stretches of time potentially introducing new errors along the way. These new errors can be costly because the user may need to go back and repeat the preflight. For example, the user may create artwork in the document which may be incompatible with the preflight rules that cover printing requirements. Recognizing the incompatibility after the artwork has already been created, adjusted, reviewed, and so on, may be costly in terms of time.

The preflight flow remains the same regardless of how much time the user spends reviewing and corrects the document to remove the errors. The preflight is performed to completion before the user gets the error report. After correction, the preflight is again performed to completion before the user gets another error report, and so on.

For some example embodiments, the preflight may be improved by allowing the user to make a correction substantially in parallel with the preflight. The user does not have to wait until the preflight is completed. The preflight may be applied to any printing and/or publication processes that may enable the user to save time and expenses associated with correcting errors due to conflicts, collisions, and/or errors. The preflight techniques described herein may be implemented in software, hardware, or a combination of both.

In the following discussions, a preflight may also be referred to an inspection process that is performed by a preflight engine. Preflighting a document or a portion of the document may also be referred to as inspecting the document or the portion of the document. An inspected portion may be associated with an inspection result. Depending on the rules of the preflight profile used by the preflight engine, the inspection result may include errors found, or it may not include any errors. The inspection result may be sent to a user to review and to make correction to the document (or the portion of the document) to remove the errors. A subsequent re-inspection or revalidation may be performed by the preflight engine.

### Preflight System

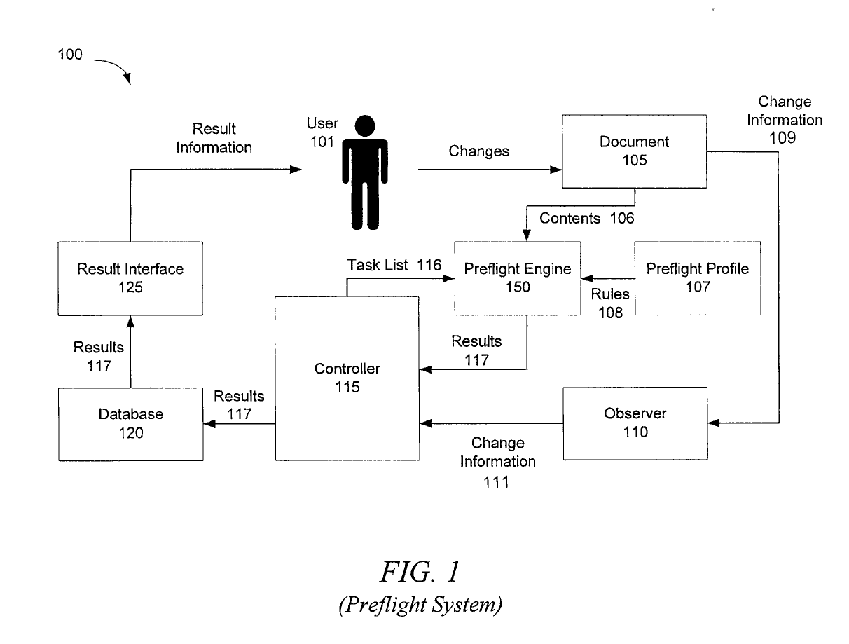

FIG. 1 illustrates an example of a preflight system, in accordance with some example embodiments. Preflight system 100 may include a preflight engine 150, a database 120, a controller module (or controller) 115, an observer module (or observer) 110, a database 120, and a results interface 125. The controller 115 may interact with the preflight engine 150, the observer 110, and the database 120. The preflight engine 150 may receive contents 106 of the document 105 and rules 108 included in the preflight profile 107 as input. The contents 106 of the document 105 may include, for example, text, images, attributes, etc. The preflight engine 150 may apply the rules 108 against the contents 106. The preflight engine 150 may also receive information from the controller 115 to adjust its internal state. This may be in the form of an interrupt signal (e.g., wake up signal). For example, the information may notify the preflight engine 150 to be prepared to preflight contents of another document. The preflight engine 150 may generate results 117 and send the results 117 to the controller 115. The results 117 may include information such as, for example, “page 1 has no errors”, “image 6 does not have sufficient resolution”, etc.

For some example embodiments, the preflight engine 150 may operate substantially in parallel with operations of the user 101. For example, the user 101 may be viewing and editing the document 105 while the preflight engine 150 may be operating in the background. The user 101 may be a person or an entity that is capable of reviewing errors related to the results 117 generated by the preflight engine 150. The user 101 may then make correction or changes to the document (or a portion) 105. A results user interface 125 may be used to view the errors. For example, the user 101 may be a server performing services on behalf of a web site.

For some example embodiments, operations associated with preflighting the document 105 (or portions of the document) and operations associated with displaying the errors and/or the document 105 to enable the user 101 to view and to make changes may be implemented substantially in parallel using separate threads or using time slices in a single-threaded application. Multi-threading and time-slicing techniques are techniques that enable parallel processing and/or multi-taskings.

The database 120 may be configured to store information related to portions of the document 105 that have been inspected by the preflight engine 150. The database 120 may also store the results 117 associated with the portions of the document that have been inspected. Size of a portion may vary depending on implementation. For example, a portion may range anywhere from the entire document 105 to extremely fine-grained pieces of the document 105 such as, for example a single character of text on a page. The results 117 stored in the database 120 may be displayed via the results interface 125. It may be noted that the results 117 may be formatted between when it is sent from the preflight engine 150 and when it is displayed in the results interface 125. The results interface 125 (also referred to as a visual feedback interface) may be used by the preflight system 100 to provide visual feedback to the user 101. When there are errors to be corrected, the errors may be highlighted to provide visual recognition. For some example embodiments, visual formatting (e.g., error highlighting, etc.) may be performed by the controller 115 and/or the result interface 125.

The observer 110 is configured to observe changes in the document 105. The observer 110 may examine the change information 107 and determines the portion(s) of the document 105 that is affected by the change. The observer 110 may provide the results of its determination to the controller 115. These results (also referred to as the scope of validation) 108 may identify the portions of the document 105 that the controller may need to revalidate. For some example embodiments, the determination of the portions of the document 105 affected by the change may be performed by the observer 110, the controller 115, or by both the observer 110 and the controller 115.

Responsive to receiving the scope of validation information 108 from the observer 110, the controller 115 may access the database 120 and update status of the stored results 117 that are related to the change information. For example, when the controller 115 determines that a portion “A” of the document 105 has been updated, then the controller 115 may revalidate (or re-preflight) that portion “A”. The controller 115 may then update the results 117 associated with the portion “A” since those results may no longer be valid.

Embodiments of the present invention may enable the preflight engine 150 and the controller 115 to continue to operate on the document 105 and/or revalidation of portions of the document 105 while the user 101 is able to view the errors on the results user interface 125. This is different from the traditional preflight approach where the preflight and the error viewing operations occur in sequence.

### Preflight Process

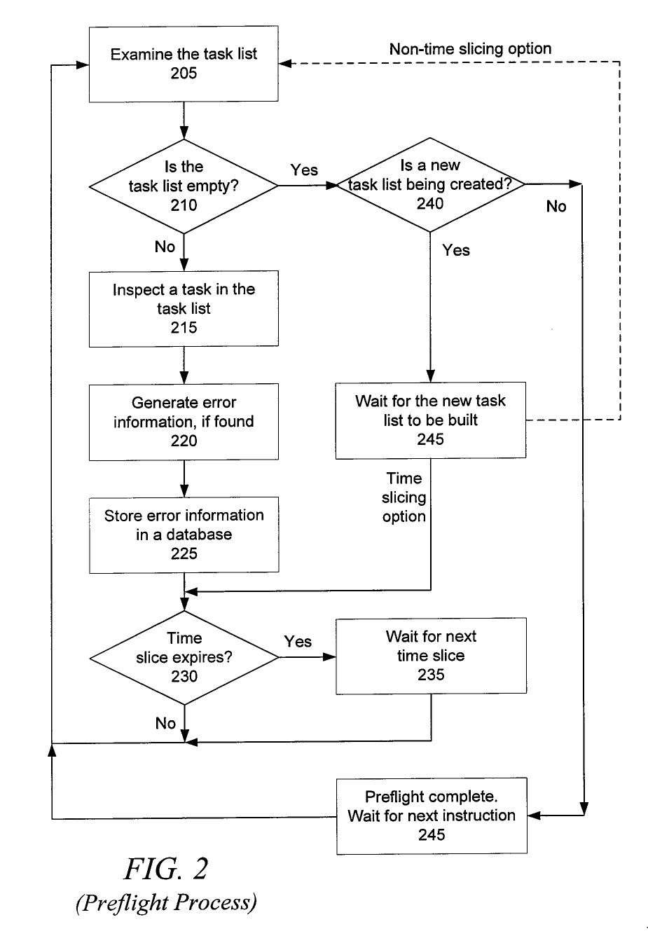

FIG. 2 is a block diagram illustrating a preflight process, in accordance with some example embodiments. The process may be performed by a system that includes components similar to the system 100 described in FIG. 1. At block 205, a preflight engine 150 may examine a task list 116 to determine a task to process. The task list 116 may contain information related to portions of a document 105 that may need to be inspected or preflighted. The task list 116 may also contain portions of the document 105 that may need to be revalidated. At block 210, it is determined whether the task list 116 is empty. If the task list 116 not empty, the process may flow to block 215 where the preflight engine 150 may process a task in the task list 116. As described above, a task may be associated with a portion of the document 105 that needs to be inspected or revalidated. Using the rules 108 of the preflight profile 107, the preflight engine 150 may inspect the portion of the document 105 to determine whether there are any errors.

If errors are found, information about the errors is generated, as illustrated in block 220. For example, an error report may be generated. At block 225, the error information may be stored in the database 120. When the preflight engine 150 is implemented using time-slicing, a test may be performed to determine if the current time slice has expired, as illustrated in block 230. If the time slice has expired, the process may flow to block 235 where the preflight engine 150 may need to wait for another time slice to be allocated. When that occurs, the process may return to block 205 to repeat the operations.

From block 210, if the task list 116 is empty, the process may flow to block 240. For some example embodiments, the task list 116 may be empty while new tasks are being created by the controller 115 based on information stored in the database 120. At block 240, it is determined whether new tasks are being created. If they are being created, the process may flow to block 245 to wait for the new tasks. The process may then flow to block 230 to determine whether to wait for a next slice if the preflight engine 150 is implemented using time-slicing. If time-slicing is not implemented, the process may continue to wait in block 245 until a signal is received to indicate that the new tasks have been created. In this situation, the process may flow from block 245 to block 205.

From block 240, if no new task is being created, then the preflight engine 150 may have completed the preflight for the document 105. The preflight engine 150 may go into an idle state and wait for signals (or interrupt) to transition out of the idle state, as illustrated in block 245. For example, the signal may indicate that there is a new document to preflight. When the signal is received, the preflight engine 150 may return to block 205 to repeat the operations.

### The Observer

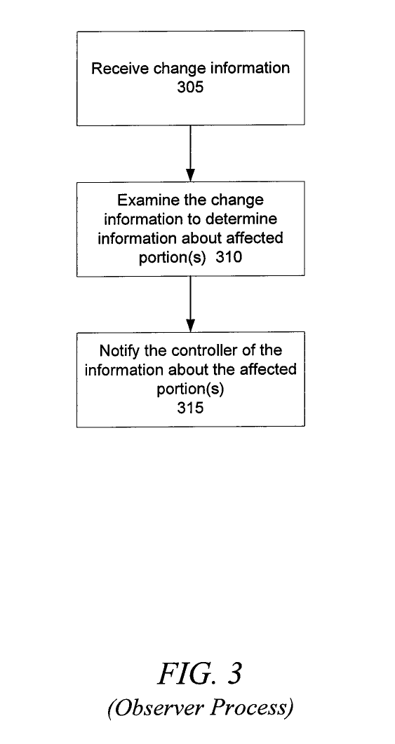

FIG. 3 is a block diagram that illustrates a process that may be performed by an observer, in accordance with some example embodiments. The observer 110 may monitor for changes that occur to the document 105. The observer 110 may receive the change information 107 from logic associated with the document 105, as illustrated in block 305. For example, this logic may report change information caused by the user 101 when editing the document 105. In some cases a change may affect only one portion, or a group of portions, or perhaps even the whole document 105. For example, when the user 101 modifies some texts, the modification may affect only a portion of one page, or it may affect all subsequent pages.

At block 310, the observer 110 may examines the change information 107 and determine the portions of the document 105 that are affected by the change. At block 315, the observer 110 notifies the controller 115 about the affected portions. The controller 115 may then consider its current task and, if the current task is affected by the change, resets the current task to empty and interrupts any inspection currently underway (e.g., in a threaded configuration) by the preflight engine 150. As described above, the controller 115 may perform the determination of the portions of the document 105 that are affected by the change, or it may make the determination along with the observer 110.

### Data Structure—Non-Overlapping

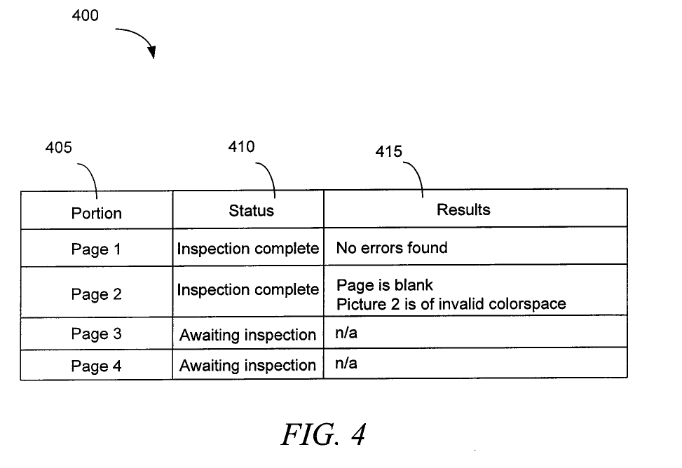

FIG. 4 is a table that illustrates data structure examples that may be used to store data in a database, in accordance with some example embodiments. For some example embodiments, the portions of the document inspected by the preflight engine 150 may be non-overlapping and non-hierarchical (e.g., each of the pages of a document is represented as an independent entity). The database 120 may store information about portions of the document 105 that have been inspected by the preflight engine 150, and error (or conflict) information associated with each inspected portion. This information may come from the preflight engine 150. Information about the portions that have not been inspected or portions that need to be re-validated is also stored. This information may be received the observer 110 and may be used by the preflight engine 150.

Referring to FIG. 4, table 400 includes three columns. Column 405 may include information about the different portions of the document 105. Here, each portion of the document 105 is a page including page 1 to page 4. Column 410 may include information about inspection status of each portion. The inspection status may be, for example, “complete” or “awaiting”. Column 415 may include results information for the portions that have been inspected. The results information may indicate whether errors were found during the inspection and what the errors are.

The information included in the first column 405 and in the second column 410 may be used by the preflight engine 150 to determine the next portion to inspect. The results information in the last column 415 may be used by a user to correct the errors found by the preflight engine 150.

Controller Process—with Non-Overlapping Data Structure

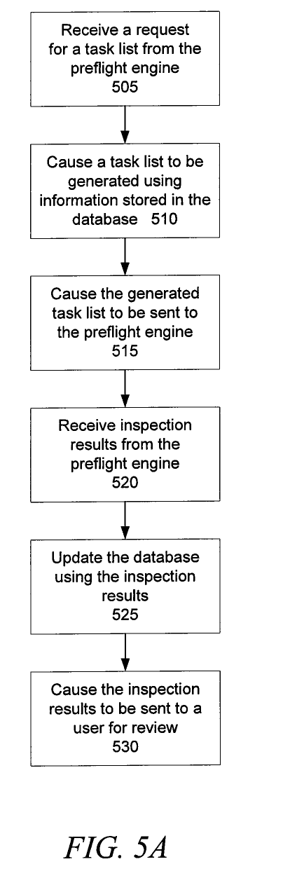

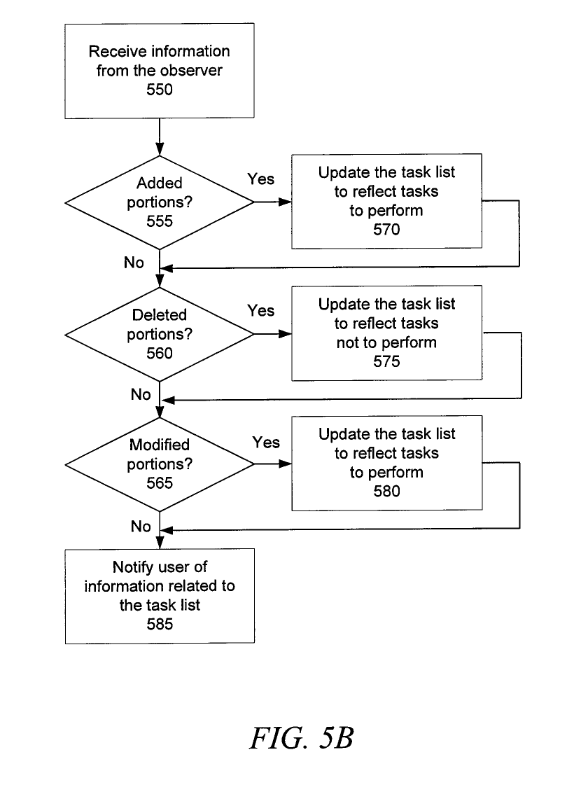

FIG. 5A is a block diagram that illustrates a process that may be performed by a controller when interacting with a database and a preflight engine, in accordance with some example embodiments. This process may be used with the data structure described with FIG. 4. The process may start at block 505 where the controller 115 receives a request for a task list from the preflight engine 150. The controller 115 may operate with the database 120 to generate a task list that includes all portions that are waiting for inspection. The resulting task list may then be sent to the preflight engine 150, as illustrated in block 515.

The preflight engine 150 may apply the rules of the preflight profile 107 to the portions on the task list. The preflight engine 150 may generate inspection results (also referred to as errors, conflicts, or collision) and send the inspection results to the controller 115. At block 520, the controller 115 receives the inspection results. At block 525, the controller 115 uses the inspection results to update the database 120. This may include updating the status of each of the affected portions and their corresponding inspection results, as illustrated in columns 410 and 415 of FIG. 4. At block 530, the controller 115 may cause the inspection results to be sent to the user 101. This may be via the result interface 125.

FIG. 5B is a block diagram that illustrates a process that may be performed by a controller when interacting with an observer, in accordance with some example embodiments. The process may start at block 550 where the controller 115 receives information from the observer 110. At block 555, it is determined whether the information received from the observer includes new portions to be inspected. For example, the new portions may include new pages added by the user 101 as the user works on the document 105. If there are new portions, the controller 115 updates the task list accordingly, as illustrated in block 570. The process then flow to block 560.

From block 555, if there are no new portions, it is then determined if existing portions are deleted, as illustrated in block 560. If portions are deleted from the document 105, the controller 115 updates the task list to reflect that change. This may include, for example, removing information about the deleted portions from the task list since there is nothing to inspect. If there are deleted portions, the controller 115 updates the task list accordingly, as illustrated in block 575. The process then flow to block 565.

From block 560, if there are no deleted portions, it is then determined if there are modified portions, as illustrated in block 565. If portions are modified, the controller 115 adds information about the modified portions to the task list for re-inspection. At block 585, the controller 115 sends a message to the user 101 indicating that results have been updated. This may be via the result interface 125. As noted above, the portion may vary depending on the implementation, and performance may be a factor to consider when determining the size of the portion especially when time slicing is used.

### Data Structure—Hierarchical

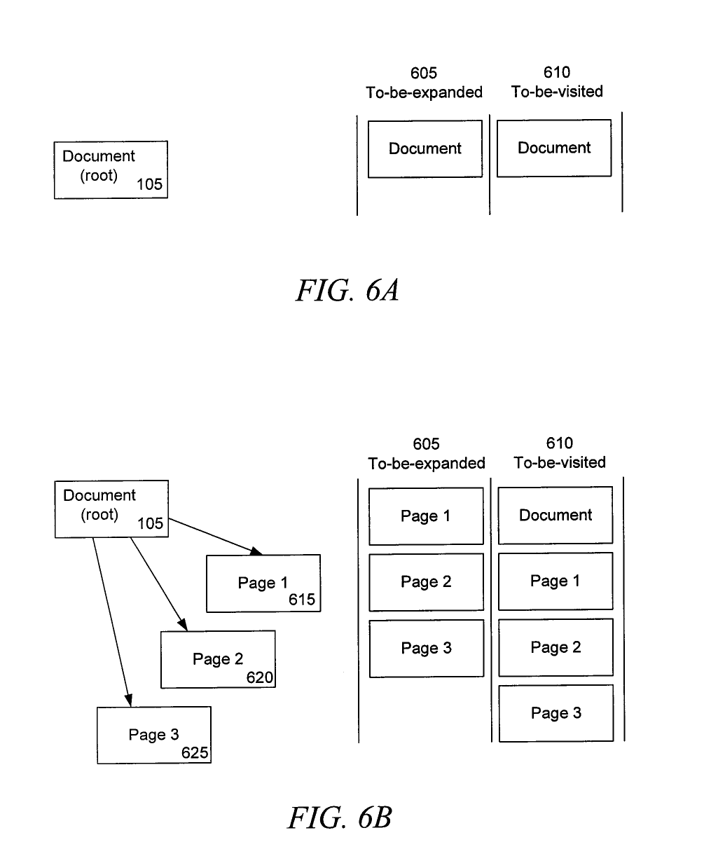

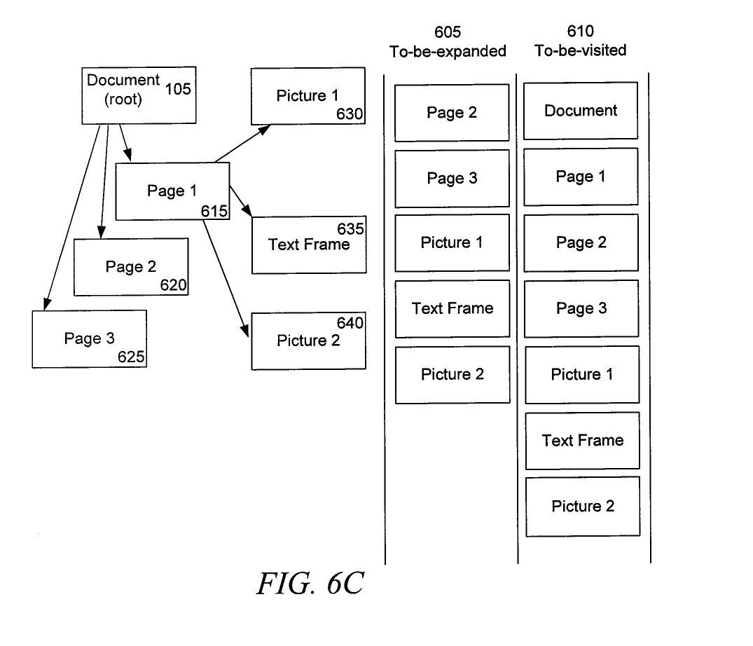

For some example embodiments, the information stored in the database 120 may be organized into lists of nodes that are related to one another. At initialization, the database 120 may be populated with a single root node, which is a reference to the document 105. The to-be-expanded and to-be-visited nodes are initialized to contain only the document node. This is illustrated in FIG. 6A where the root node (document 105) is included in the list of nodes to be expanded 605 and in the list of nodes to be visited 610. For some example embodiment, nodes included in the list nodes to be expanded 605 may be examined iteratively until all the nodes are expanded. The expansion may be performed by the controller 115.

FIG. 6B illustrates a directed graph that includes a root node and related nodes, in accordance with some example embodiments. In this example, the directed graph on the left includes a root node (the document 105) and its three children nodes (pages 615-625). For some example embodiments, when a node is included in the list of nodes to be expanded 605, its children nodes have yet to be added to the directed graph. When a node is included in the list of nodes to be visited 610, that node has not been inspected by the preflight engine 150. The list of nodes to be visited 610 corresponds to the task list described above. In the current example, the list of nodes to be expanded 605 includes the three children nodes that correspond to pages 615-620 but not the root node because the root node has already been expanded. The list of nodes to be visited 610 includes the root node and its children nodes because they have not been inspected. For some example embodiments, each child node may be considered a portion of the document to be inspected.

The directed graph of FIG. 6B may continue to expand until there are no more nodes to be expanded. As mentioned above, a node that has been expanded is removed from the list of nodes to be expanded. In the current example, the node that corresponds to the page 615 may be expanded to three nodes that correspond to first picture 630, text frame 635 and second picture 640. This is illustrated in FIG. 6C where the list of nodes to be expanded 605 does not include the node that corresponds to the page 615. However, its children nodes (first picture 630, text frame 635 and second picture 640) are included in the list of nodes to be visited 610.

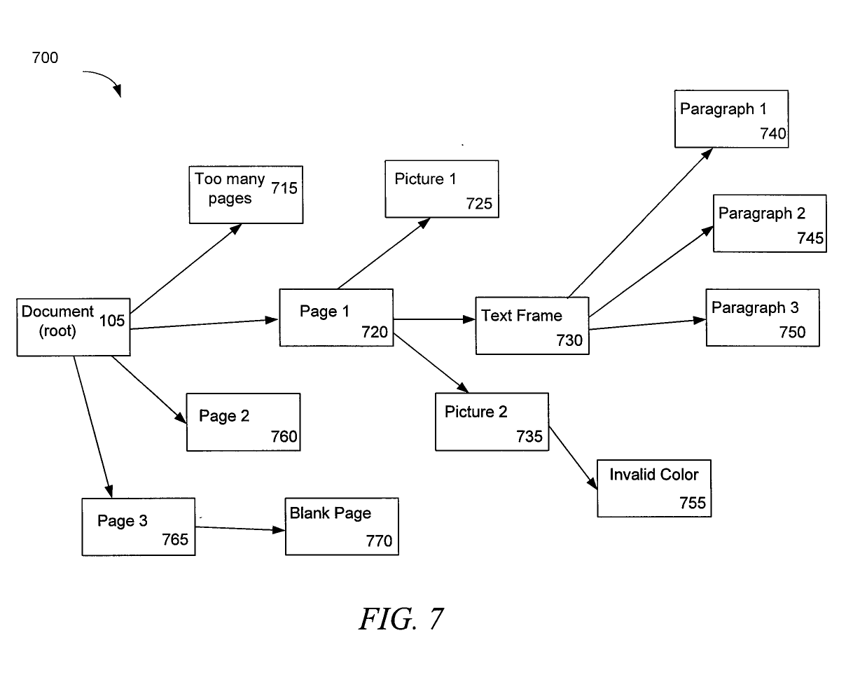

FIG. 7 illustrates an example directed graph, in accordance with some example embodiments. Directed graph 700 includes nodes that are connected by directional links, or pointers. The nodes include object nodes and result nodes. An object node refers to an element in the document 105, while a result node contains the results from the preflight engine 150. The directed graph 700 may include object nodes that are children of other object nodes. An object node may or may not be associated with a result node depending on whether the preflight engine 150 generates any results for an inspected object node. For example, nodes 715, 755 and 770 are result nodes, while the remaining nodes are object nodes.

Note that the directed graph 700 (also referred to as a preflight graph) may or may not be a one-to-one correspondence with the structure of the document 105. However, the preflight engine 150 needs to understand how the nodes are used in the database 120. For example, the preflight engine 150 may need to look at logical objects that are not actually present in the document 105 but are useful for preflight purposes. For example, the directed graph 700 includes three nodes that represent paragraphs 740-750 even though the document 105 may only express text in terms of arrays of characters. This is because, for preflight purposes, it may be more useful to describe them as words, sentences, or paragraphs.

For some example embodiments, instead of having the result nodes, the results may be added to the object node as a property of the object node. It may be noted that the examples illustrated in FIGS. 6A-6C expands all the nodes before they are visited. For some other example embodiments, the nodes in the list of nodes to be visited 610 may be sent to the preflight engine 150 for inspection before all possible expansion is completed. When the list of nodes to be visited 610 is empty, additional node expansion may occur. This may allow the preflight engine 150 to report errors proportionally and sooner to the user with possibly minimal impact on total inspection time. For some example embodiments, information about the results and the objects may be stored along with the document instead of having to organize them using the hierarchical data structure described in this section. This may be implemented using indexing and metadata. For example, indexing may be used to keep track of the portions that have been inspected and those that have not been inspected. Metadata may be used to associate inspection results with corresponding portions of the document that have been inspected.

Controller Process—with Hierarchical Data Structure

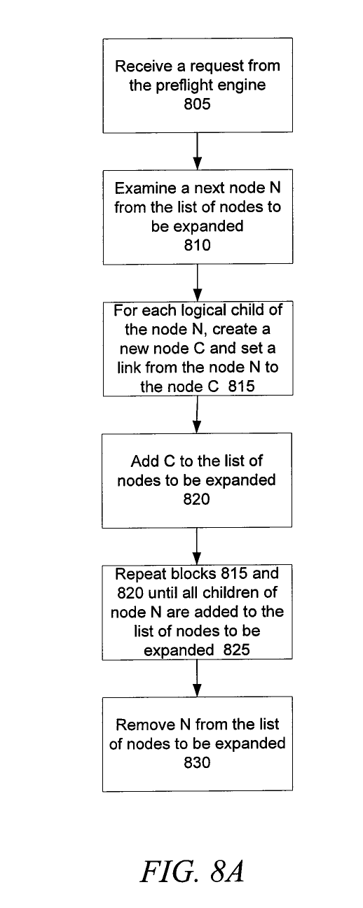

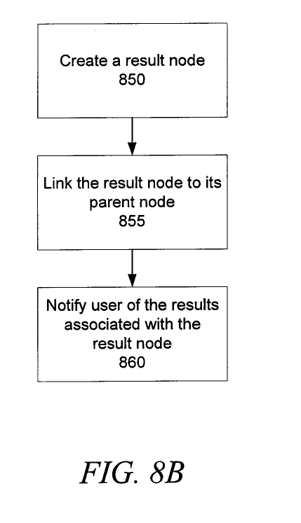

FIG. 8A is a block diagram that illustrates a process that may be performed by a controller, in accordance with some example embodiments. This process may be used with the data structure described with FIGS. 6A-6C and 7. The process assumes that the list of nodes to be expanded 605 is not empty. The process may start at block 805 where the controller 115 receives a request for a task list (or list of nodes to be inspected) from the preflight engine 150.

At block 810, a node N from the list of nodes to be expanded 605 is examined to determine its children nodes. At block 815, a child node C of the node N is created. This may include adding the child node C to the direct graph linking it to the node N. At block 820, the child node C is added to the list of nodes to be expanded 605. The operations described in blocks 815 and 820 may be repeated until all the children nodes of the node N are processed. At block 830, the node N is removed from the list of nodes to be expanded 605. It may be noted that the list of nodes to be expanded 605 may be empty eventually. The controller 115 may then provide the list of nodes to be examined 610 to the preflight engine 150.

In a time-slice implementation, when a time slice expires, the process of FIG. 8A may have to wait for the next time slice. The controller 115 may need to notify the preflight engine 150 that a task list is being generated so that the preflight engine 150 can expect the task list. This is related to the operations in block 240 of FIG. 2. While the controller 115 is waiting for the next time slice, the result interface 125 may be operating with its time slice. Alternatively, the process of FIG. 8A may iterate until all of the children nodes are expanded while the preflight engine 150 waits.

FIG. 8B is a block diagram that illustrates a process that may be performed by the controller when inspection results are generated by the preflight engine, in accordance with some example embodiments. At block 850, the controller 115 creates a result node and associates the result generated by the preflight engine 150 with the result node. At block 855, the controller 115 adds the result node to the directed graph by linking the result node to its corresponding parent object node. This associates the results with the correct portion of the document 105. For example, if an error was found with a picture, the results-node contains the nature of the error and the picture will have a new child node which is that results node. At block 860, a notification may be sent to the result interface 125.

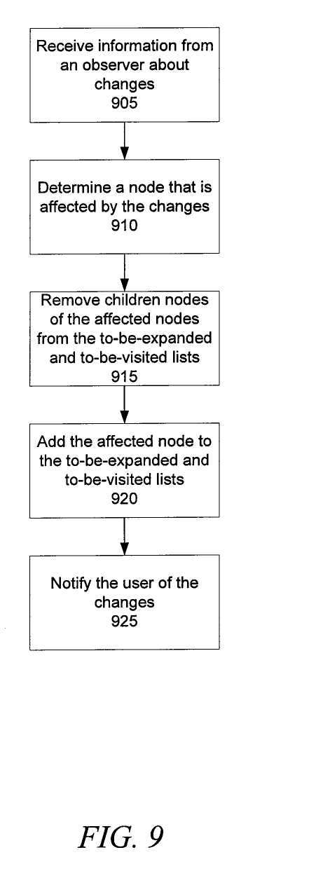

FIG. 9 is a block diagram that illustrates a process that may be performed by the controller when receiving information from an observer, in accordance with some example embodiments. The process may start at block 905 when the controller 115 receives information from the observer 110 indicating that a change to the document 105 has occurred (e.g., the user modified the document). At block 910, the controller 115 may determine the affected node. At block 915, the controller 115 may remove the children nodes of the affected nodes from the database 120. This may include removing the associated results nodes. This may also include removing the children nodes from the to-be-expanded and to-be-visited lists, if they appear there. This may be necessary to maintain the integrity of these lists

At block 920, the controller 115 adds the affected node to the to-be-expanded and to-be-visited lists 605, 610 so that on the next task list request from the preflight engine 150, the directed graph may be expanded starting from that affected node. At block 925, the user is notified of the change since the results have changed. It may be noted that this process may assume that the observer 110 considers a node to be affected if any changes occur to its children nodes.

### Modules, Components and Logic

Certain embodiments are described herein as including logic or a number of components, modules, or mechanisms. A component may be a tangible unit capable of performing certain operations and is configured or arranged in a certain manner. In example embodiments, one or more computer systems (e.g., a standalone, client or server computer system) or one or more components of a computer system (e.g., a processor or a group of processors) may be configured by software (e.g., an application or application portion) as a “component” that operates to perform certain operations as described herein.

In various embodiments, a “component” may be implemented mechanically or electronically. For example, a component may comprise dedicated circuitry or logic that is permanently configured (e.g., within a special-purpose processor) to perform certain operations. A component may also comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software) may be driven by cost and time considerations.

Accordingly, the term “component” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components are temporarily configured (e.g., programmed), each of the components need not be configured or instantiated at any one instance in time. For example, where the components comprise a general-purpose processor configured using software, the general-purpose processor may be configured as respective different components at different times. Software may accordingly configure a processor, for example, to constitute a particular component at one instance of time and to constitute a different component at a different instance of time.

Components can provide information to, and receive information from, other components. Accordingly, the described components may be regarded as being communicatively coupled. Where multiple of such components exist contemporaneously, communications may be achieved through signal transmission (e.g., over appropriate circuits and buses) that connect the components. In embodiments in which multiple components are configured or instantiated at different times, communications between such components may be achieved, for example, through the storage and retrieval of information in memory structures to which the multiple components have access. For example, a one component may perform an operation, and store the output of that operation in a memory device to which it is communicatively coupled. A further component may then, at a later time, access the memory device to retrieve and process the stored output. Components may also initiate communications with input or output devices, and can operate on a resource (e.g., a collection of information).

The term “module”, as used herein, should be understood to refer more broadly to a tangible component or a software component, or any combination thereof. Accordingly, a module may be implemented in electronic circuitry, hardware, firmware, software or a combination thereof.

### Electronic, Apparatus and System

Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA (field programmable gate array) or an ASIC (application-specific integrated circuit).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination permanently and temporarily configured hardware may be a design choice. Below are set out hardware (e.g., machine) and software architectures that may be deployed, in various example embodiments.

### Example Machine Architecture and Machine-Readable Medium

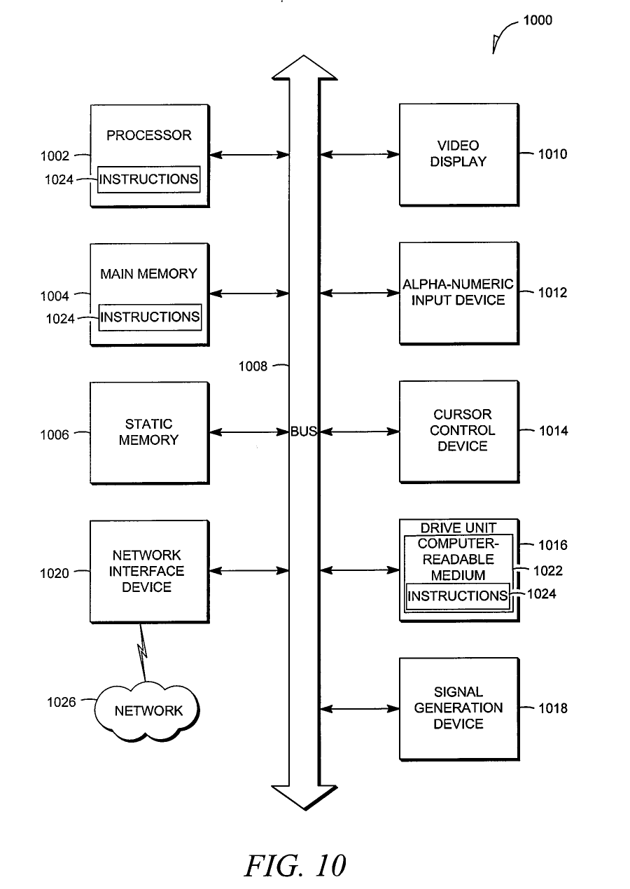

FIG. 10 is a block diagram of machine in the example form of a computer system within which instructions, for causing the machine to perform any one or more of the methodologies discussed herein, may be executed, in accordance with some example embodiments. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

### Transmission Medium

The software 1024 may further be transmitted or received over a communications network 1026 using a transmission medium via the network interface device 1020 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks) The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
preflighting a first portion of a document having multiple portions including the first portion and a second portion;
receiving a change to one of the first portion or the second portion;
determining an affected node corresponding to the first portion or the second portion that is affected by the change;
removing children nodes of the affected node from a to-be-visited list the to-be-visited list comprising a list of nodes to be preflighted;
adding the affected node to a to-be-expanded list and the to-be-visited list, the to-be-expanded list comprising a list of nodes to be expanded;
generating, using at least one processor, preflight results associated with the first portion; and
displaying the preflight results associated with the first portion concurrently with preflighting the second portion.

2. The method of claim 1, wherein the preflight results associated with the first portion and preflight results associated with the second portion are stored in a database.

3. The method of claim 2, further comprising:
receiving change information associated with a third portion after the preflight results associated with the second portion are generated, the third portion being included in the multiple portions, the third portion being previously preflighted;
removing stored preflight results associated with the third portion;
notifying the user of the removing of the stored preflight results associated with the third portion; and
generating new preflight results associated with the third portion based on the change information.

4. The method of claim 1, further comprising:
receiving change information related to the change in the document;
determining whether a current task is affected by the change information; and
based on the change information affecting the current task, resetting the current task to empty and interrupting inspection currently underway.

5. The method of claim 1, wherein said preflighting the first portion and receiving the change are performed using separate threads.

6. The method of claim 1, wherein said preflighting the first portion and receiving the change are performed using time slicing.

7. A method for preflighting a document, the method comprising:
organizing, using at least one processor, a document into multiple portions including a first portion and a second portion, each of the multiple portions to be preflighted using a preflight engine and rules associated with a preflight profile;
preflighting the first portion of the document;
receiving a change to one of the first portion or the second portion;
determining an affected node corresponding to the first portion or the second portion that is affected by the change;
removing children nodes of the affected node from a to-be-visited list, the to-be-visited list comprising a list of nodes to be preflighted;
adding the affected node to a to-be-expanded list and the to-be-visited list, the to-be-expanded list comprising a list of nodes to be expanded; and
displaying preflight results associated with the first portion of the document without completing preflight for the entire document.

8. The method of claim 7, further comprising preflighting the second portion of the document concurrently with the displaying of the preflight results associated with the first portion, wherein said preflighting of the second portion of the document is performed in a background.

9. The method of claim 7, wherein the preflight engine operates in a multi-threaded environment, wherein the preflighting of the first portion of the document is performed using a first thread, and wherein said receiving the change is performed using a second thread,

10. The method of claim 7, wherein the preflight engine operates in a time-slicing environment, wherein the preflighting of the first portion of the document is performed using a first time slice while said receiving the change is performed using a second time slice after the first time slice expires.

11. The method of claim 8, further comprising:
storing the preflight results associated with the first portion and preflight results associated with the second portion.

12. The method of claim 11, further comprising:
responsive to receiving an updated first portion, removing the stored preflight results associated with the first portion.

13. The method of claim 12, further comprising:
storing a third portion of the document while the third portion is waiting to be preflighted by the preflight engine.

14. The method of claim 13, wherein the first portion, the preflight results associated with the first portion, the second portion, and the third portion are stored according to a hierarchy data structure.

15. The method of claim 7, wherein each of the multiple portions is to be preflighted according to a hierarchy data structure.

16. A non-transitory machine-readable medium having instructions that, when executed by processor of a machine, cause the machine to perform operations comprising:
preflighting a first portion of a document having multiple portions including the first portion and a second portion;
receiving a change to one of the first portion or the second portion;
determining an affected node corresponding to the first portion or the second portion that is affected by the change;
removing children nodes of the affected node from a to-be-visited list, the to-be-visited list comprising a list of nodes to be preflighted;
adding the affected node to a to-be-expanded list and the to-be-visited list, the to-be-expanded list comprising a list of nodes to be expanded; and
displaying preflight results associated with the first portion without completing preflight for the entire document while concurrently preflighting the second portion, the preflighting of the first portion and the second portion being based on rules associated with a preflight profile.

17. The machine-readable medium of claim 16, wherein said preflighting the first portion and said receiving the change are performed substantially in parallel using multi-threads or time slicing.

18. (canceled)

19. A system, comprising:
at least one processor;
a preflight engine;
a controller module coupled to the preflight engine, the controller module to manage portions of a document to be preflighted that include a first portion and a second portion, the preflight engine being capable of preflighting the first portion of the document, the preflight engine capable of displaying preflight results associated with a first portion without completing preflight for the entire document; and
an observer module coupled to the controller module and configured to monitor for changes in the document without completing the preflight for the entire document and to notify, using the at least one processor, the controller module when changes to the document are detected
the controller to receive a notification of the changes to one of the first portion or the second portion, to determine an affected node corresponding to the first portion or the second portion that is affected by the change, to remove children nodes of the affected node from a to-be-visited list the to-be-visited list comprising a list of nodes to be preflighted, and to add the affected node to a to-be-expanded list and the to-be-visited list, the to-be-expanded list comprising a list of nodes to be expanded.

20. The system of claim 19, wherein the controller sends information related to the portions of the document to the preflight engine responsive to requests by the preflight engine.

21. The system of claim 19, further comprising:
a database coupled to the controller and configured to store the portions of the document and associated results after the portions are preflighted by the preflight engine.

22. The system of claim 21, further comprising:
a result interface coupled to the database and configured to display the results stored by the database.

23. The system of claim 19, wherein the preflight engine preflights the first portion of the document while receiving changes using multi-threadings or time slicing.

24. The system of claim 19, wherein the controller module is further to receive information related to the changes to the document;
determine whether a current task is affected by the information; and
based on the information affecting the current task, reset the current task to empty and interrupt inspection currently underway.

25. (canceled)

26. The method of claim 1, wherein the generating of the preflight results associated with the first portion comprises generating the preflight results indicating a. preflight error, the method further comprising receiving a change to the first portion to alleviate the preflight error concurrently with the preflighting of the second portion.

27. The method of claim 1, further comprising removing the children nodes of the affected node from the to-be-expanded list.
